(19) United States
(12) Patent Application Publication
(10) Pub. No.: US 2008/0185422 A1
(43) Pub. Date: Aug. 7, 2008

(54) Stainless steel for fume extracters

(76) Inventor: George Liu, Yunlin County (TW)

Correspondence Address: Joe McKinney Muncy, PO Box 1364, Fairfax, VA, 22038-1364, US

(21) Appl. No.: 11/700,880

(22) Filed: Feb. 1, 2007

(51) Int. Cl. B23K 1/20

(52) U.S. Cl. 228/203

(57) ABSTRACT

A stainless steel for a fume extractor which has a main body formed by stamping and soldering includes a stainless steel base board of a selected thickness. The stainless steel base board has the surface treated to form a coarse surface. Then the surface of the stainless steel base board is coated with a transparent lacquer to form a protection layer to prevent rusting and corrosion when submerged in a chemical detergent or exposed in a salty environment. Such a structure also facilitates wiping of filthy materials smeared on the surface.

### FIELD OF THE INVENTION

The present invention relates to a stainless steel plate of fume extractors and particularly to a stainless steel plate that has a protection layer bonded to the surface to prevent rusting and corrosion and facilitate removing of filthy material on the surface.

### BACKGROUND OF THE INVENTION

During cooking fume is generated. The fume and dust in the air easily attract sticky filthy materials. Moreover, various types of condiments such as salt, liquor, sauce, vinegar, sugar and the like are added during cooking, and rise with the fume and heated vapor. After a period of time the surface of the fume extractor is smeared with a layer of filthy grease. This grease layer is difficult to remove through an ordinary detergent and water. The fume extractor is made of metal. To do cleaning by scrubbing with the aid of a powerful detergent and brushes tends to scrape the surface of the metal plate. If the metal plate is coated with paint on the surface, visible scraping traces are often formed after cleaning and brushing. The general fume extractor often has a sticky grease layer attached thereon after use for one or two years. The sticky grease also attaches to the inner wall of the chassis and air fan. It is difficult to fully remove the sticky grease through the ordinary detergent. Hence cleaning often has to be done by outside specialists. To do this they often disassemble the chassis and submerge it in a heavy duty detergent for a period of time to soften the grease before clearing. Such a process tends to damage the surface coating and results in rusting. Moreover, the heavy duty detergent also is corrosive. While it can dissolve the grease, it also causes corrosion and damages the coating of the chassis. This is a common problem occurred to the conventional fume extractors yet to be overcome.

### SUMMARY OF THE INVENTION

The primary object of the present invention is to provide stainless steel for fume extractors. A fume extractor according to the invention has a main body formed by stamping and soldering the stainless steel. The stainless steel includes a stainless steel base board at a selected thickness. The stainless steel base board is treated to form a coarse surface. Then a transparent lacquer is coated on the surface of the stainless steel base board to form a protection layer so that rusting and corrosion can be prevented when in use later during submerging in the detergent or exposed to a salty environment. It also can facilitate daily wiping and cleaning of the surface thereof.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of a fume extractor according to the invention.

FIG. 2 is a fragmentary cross section of the invention.

FIG. 3 is a block diagram of the fabrication process of the invention.

### DETAILED DESCRIPTION OF THE PREFERRED EMBODIMENT

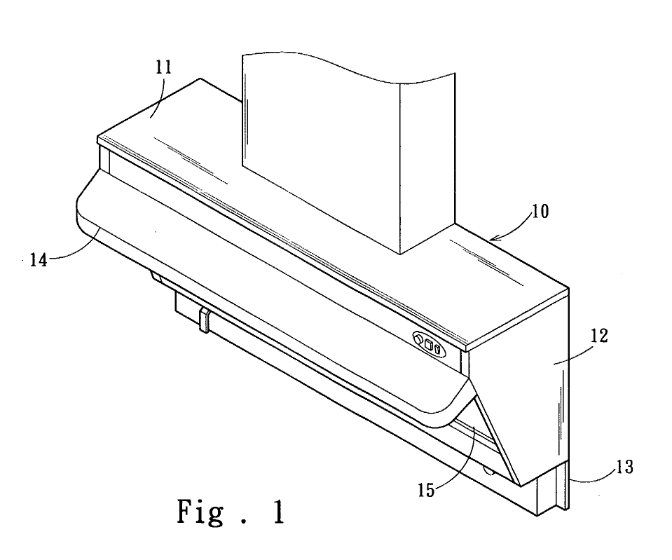

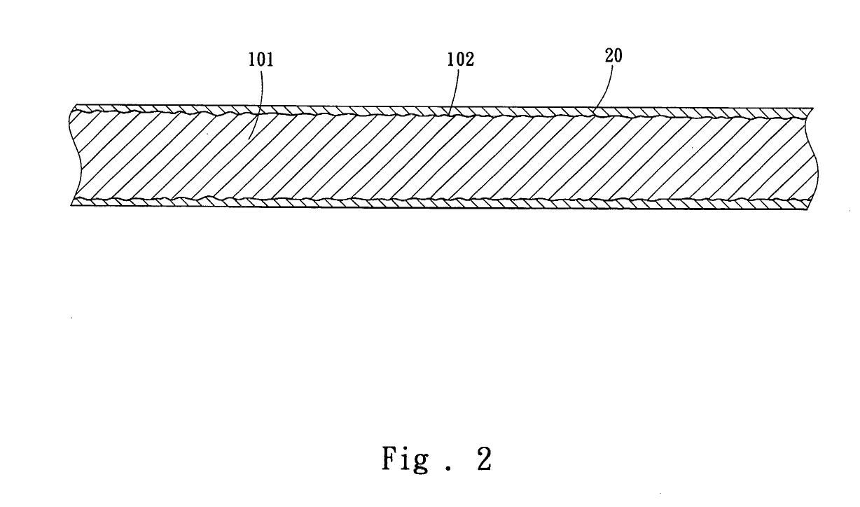

Please refer to FIG. 1, the fume extractor made of the stainless steel of the invention mainly includes a chest type main body 10 which has a horizontal top surface 11, two side walls 12 on the left side and right side and a back panel 13 leaning against a wall. There is a detent plate 14 at a front side such that the bottom of the main body 10 form an extracting hood 15 corresponding to a stove of a kitchen counter to absorb and discharge fume during cooking. The stainless steel is formed through a stainless base board 101 by stamping and soldering to become a chest. Referring to FIG. 2, the surface of the stainless base board 101 is treated in advance to form a coarse surface 102 with regular or irregular textures. Then the coarse surface 102 is coated with a layer of transparent lacquer to form a protection layer 20.

Because of the coarse surface 102 the protection layer 20 formed by coating the transparent lacquer has a stronger bonding force and does not easily peel off.

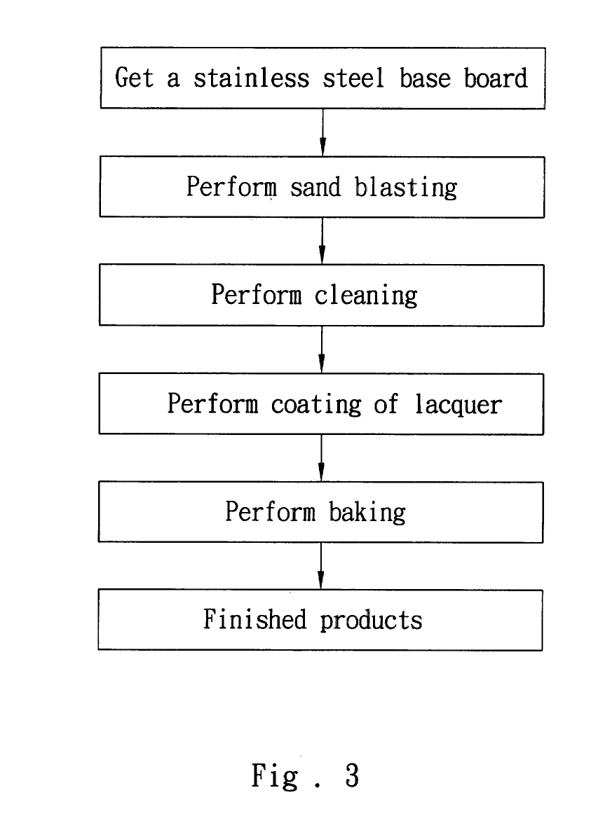

Refer to FIG. 3 for the fabrication process of the invention. First get a stainless steel base board 101; perform sand blasting on the upper and lower surfaces thereof; clean the surfaces to remove debris; evenly coat a transparent lacquer on the surface of the stainless base board 101 to form a protection layer 20; bake the stainless steel in an oven at a temperature between 140. and 250. so that the protection layer 20 is bonded to the surface of the stainless base board 101; finally remove the finished goods.

The fume extractor thus formed has the protection layer 20 bonded to the surface of the stainless steel base board 101 to isolate salt, dust and grease in the environment from directly attaching to the surface of the stainless steel base board 101. Hence rusting and corrosion can be prevented. Ordinary wiping only touches the surface of the protection layer 20 without producing scraping traces on the stainless steel base board 101.

Prototypes of the invention have been made. The object and expecting results are fully accomplished. It provides a significant improvement over the conventional products.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A stainless steel for a fume extractor which is formed by stamping and soldering of the stainless steel, comprising a stainless steel base board and a protection layer formed by coating a transparent lacquer on the surface of the stainless steel base board.

2. The stainless steel for the fume extractor of claim 1, wherein the surface of the stainless steel base board is treated to form a coarse surface before coating the transparent lacquer to form the protection layer.
